(19) United States
(12) Patent Application Publication
(10) Pub. No.: US 2020/0139576 A1
(43) Pub. Date: May 7, 2020

(54) Method for Preparing Cold-Pressing Adhesive and Cold-Pressing Processing System for Plant Fiber Boards

(71) Applicant: Ying Li, Beijing (CN)

(72) Inventor: Ying Li, Beijing (CN)

(21) Appl. No.: 16/183,657

(22) Filed: Nov. 7, 2018

(51) Int. Cl. B27N 3/00; B27N 3/04; B27N 3/20; B27N 3/18

(52) U.S. Cl. CPC B27N 3/002; B27N 3/183; B27N 3/20; B27N 3/04

(57) ABSTRACT

The invention relates to a method for preparing a cold-pressing adhesive and a cold-pressing processing system for plant fiber boards. The fiber board processing method comprises the following steps of: firstly, mixing plant fiber and an adhesive, and fully and uniformly stirring the mixture; then paving the uniformly mixed plant fiber and adhesive in a cold-pressing die set of a cold-pressing device for cold-pressing and curing to prepare a plant fiber block; cutting the plant fiber block into a plurality of plant fiber board blanks with a required thickness; and finally conducting edge cutting and sanding treatment on the plant fiber board blanks to obtain the plant fiber boards.

### TECHNICAL FIELD

The invention belongs to the technical field of plant fiber board production equipment, and particularly relates to a method for preparing a cold-pressing adhesive and a cold-pressing processing method for plant fiber boards.

### BACKGROUND ART

The fiber boards and particleboards available in the market currently are manufactured by hot press molding with a hot press at high temperature and high pressure after sizing and paving. This traditional hot-pressing production method requires a large amount of heat energy, so some manufacturers use boilers to provide heat, but the exhaust gas from boilers pollutes the air seriously; and other manufacturers adopt electro heating instead of boilers, which requires a large amount of electric energy. Moreover, supporting machinery required for hot press molding is very expensive, with extremely high costs in investment, which is the main reason why small enterprises are unwilling or unable to invest.

Besides, the applicant found that the inorganic adhesive used for fiber boards and particleboards is generally prepared from magnesium oxide powder and magnesium chloride aqueous solution, which are mixed based on the ratio of 1:1. Due to the fact that magnesium chloride (commonly known as halogen sheet) is likely to absorb moisture, the moisture content of prepared plywood, particleboards and fiber boards turns out to be relatively high.

### SUMMARY OF THE INVENTION

In order to solve the above problems of the prior art, the invention provides a cold-pressing processing method and system for plant fiber boards particularly suitable for small enterprises, and a special adhesive for cold-pressing processing of plant fiber boards. According to the cold-pressing processing method and system, plant fiber boards are prepared through cold-pressing, hot-pressing being not needed, with reduced investment in mechanical equipment required, and fewer energy consumption and production costs, while featuring reinforced market competitiveness, with no formaldehyde or other harmful substances released so environment-friendliness is realized, simple in structure, easy to implement and economic in costs.

In order to solve the above technical problems, the invention adopts the following technical scheme:

A cold-pressing processing method for plant fiber boards comprises the steps of: sizing and mixing, wherein plant fiber and an adhesive are mixed and fully and uniformly stirred;

paving and cold-pressing, wherein the uniformly mixed plant fiber and adhesive are paved in a cold-pressing die set of a cold-pressing device for cold-pressing and curing to prepare a plant fiber block;

cutting, wherein the plant fiber block is cut into a plurality of plant fiber board blanks with a required thickness;

edge cutting, wherein the plant fiber board blanks are subjected to final trimming and edging finishing;

and sanding treatment, wherein the surface and edge of the plant fiber board blanks are sanded to obtain the plant fiber boards.

1. Further, during sizing and mixing, a cold-pressing adhesive is mixed with plant fiber based on the ratio of 1:1.5, the cold-pressing adhesive is prepared by mixing equal amounts of magnesium sulfate aqueous solution and magnesium oxide powder, and fully and uniformly stirring the mixture, the magnesium sulfate aqueous solution is prepared by fully and uniformly mixing 45-46% by weight of magnesium sulfate, 45-46% by weight of water, and 8-10% by weight of waterproof agent, and the ratio of magnesium sulfate to water is 1:1.

Further, the plant fiber is powder or fiber of more than 200 mesh, and the purity of the magnesium oxide powder is more than 90%.

Further, the step that “the uniformly mixed plant fiber and adhesive are paved in a cold-pressing die set of a cold-pressing device for cold-pressing and curing to prepare a plant fiber block” specifically comprises the steps of injecting the uniformly mixed plant fiber and adhesive into an inner die cavity of a cold-pressing die firstly, then stacking pressing blocks in the inner die cavity on the mixture of the plant fiber powder and the adhesive in the inner die cavity, starting a cold-pressing machine to press for a period of time and then opening the cold-pressing die to obtain the molded plant fiber block.

Further, after cutting out the plant fiber board blanks and before edge cutting, the plant fiber board blanks need to be cured to reduce the moisture content, i.e. the plant fiber board blanks are put into drying equipment for stoving treatment or air-seasoning treatment to reduce the moisture content.

A cold-pressing processing system for plant fiber boards comprises:

a mixing and stirring machine, used for mixing and fully and uniformly stirring plant fiber and an adhesive therein;

a cold-pressing device, used for paving the uniformly mixed plant fiber and cold-pressing adhesive in a cold-pressing die set of the cold-pressing device for cold-pressing and curing to prepare a plant fiber block; wherein the cold-pressing device comprises a cold-pressing machine and the cold-pressing die set arranged on a cold-pressing station of the cold-pressing machine, the cold-pressing die set consists of a detachable concave frame-shaped cold-pressing die and more than one pressing block, and the shape and size of the pressing blocks are matched with an inner die cavity of the cold-pressing die; in use, the pressing blocks are stacked in the inner die cavity on the mixture of the plant fiber powder and the adhesive in the inner die cavity;

a cutting device, used for cutting the plant fiber block into a plurality of plant fiber board blanks with a required thickness;

an edge cutting machine, used for final trimming and edging finishing of the plant fiber board blanks;

and a sanding machine, used for sanding the surface and edge of the plant fiber board blanks.

Further, the lower end of the side surface of the cold-pressing die is provided with residual adhesive discharge holes, and the residual adhesive discharge holes are connected with the inner die cavity.

Further, the cold-pressing processing system for plant fiber boards also comprises drying equipment, used for stoving treatment or air-seasoning treatment of the plant fiber board blanks therein to reduce the moisture content. 1. A cold-pressing adhesive for plant fiber boards is prepared by mixing equal amounts of magnesium sulfate aqueous solution and magnesium oxide powder, and fully and uniformly stirring the mixture, the magnesium sulfate aqueous solution is prepared by fully and uniformly mixing 45-46% by weight of magnesium sulfate, 45-46% by weight of water, and 8-10% by weight of waterproof agent, and the ratio of magnesium sulfate to water is 1:1.

The invention has the beneficial effects that:

By means of the above technical scheme, plant fiber boards can be prepared through cold-pressing, hot-pressing is not needed, investment in mechanical equipment and energy consumption can be greatly reduced, production cost is reduced, market competitiveness is improved, and no formaldehyde or other harmful substances are released so environment-friendliness is realized; furthermore, the structure is simple, implementation is easy, and the cost is low. The technical scheme is particularly suitable for small enterprises and conducive to promotion and popularization.

### BRIEF DESCRIPTION OF THE DRAWINGS

FIG. 1 is a flow chart of a cold-pressing processing method for plant fiber boards according to the present invention;

FIG. 2 is a structure diagram of a cold-pressing device in a cold-pressing processing system for plant fiber boards according to the present invention;

FIG. 3 is a structure diagram of a cold-pressing die set of a cold-pressing device in a cold-pressing processing system for plant fiber boards according to the present invention;

FIG. 4 is a working principle diagram of a cold-pressing device in a cold-pressing processing system for plant fiber boards according to the present invention;

FIG. 5 is a structure diagram of a plant fiber block molded by a cold-pressing processing method and system for plant fiber boards according to the present invention.

### DETAILED DESCRIPTION OF THE INVENTION

In order to make the object, technical scheme and advantages of the present invention clearer, the present invention will be described in further detail below with reference to the drawings and embodiments. It should be understood that the specific embodiments described herein are only for the purpose of explaining the present invention and are not intended to limit the present invention.

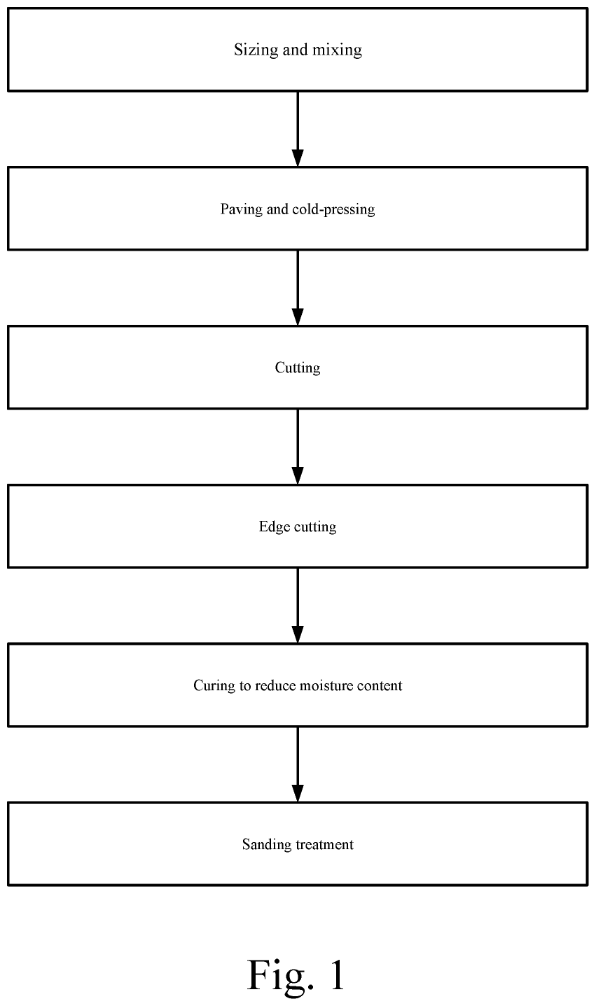

As shown in FIG. 1,

the embodiment of the invention provides a cold-pressing processing method for plant fiber boards, comprising the steps of:

1. sizing and mixing, wherein plant fiber and an adhesive are mixed and fully and uniformly stirred;

2. paving and cold-pressing, wherein the uniformly mixed plant fiber and adhesive are paved in a cold-pressing die set of a cold-pressing device for cold-pressing and curing to prepare a plant fiber block; specifically, the uniformly mixed plant fiber and adhesive are injected into an inner die cavity of a cold-pressing die firstly, then pressing blocks are stacked in the inner die cavity on the mixture of the plant fiber powder and the adhesive in the inner die cavity, a cold-pressing machine is started to press for a period of time, and then the cold-pressing die is opened to obtain the molded plant fiber block;

3. cutting, wherein the plant fiber block is cut into a plurality of plant fiber board blanks with a required thickness;

4. edge cutting, wherein the plant fiber board blanks are subjected to final trimming and edging finishing;

and 5. sanding treatment, wherein the surface and edge of the plant fiber board blanks are sanded to obtain the plant fiber boards.

1. During sizing and mixing, a cold-pressing adhesive for plant fiber boards is mixed with plant fiber based on the ratio of 1:1.5, the cold-pressing adhesive is prepared by mixing equal amounts of magnesium sulfate aqueous solution and magnesium oxide powder, and fully and uniformly stirring the mixture, the magnesium sulfate aqueous solution is prepared by fully and uniformly mixing 45-46% by weight of magnesium sulfate, 45-46% by weight of water, and 8-10% by weight of waterproof agent, and the ratio of magnesium sulfate to water is 1:1.

The plant fiber is powder or fiber of more than 200 mesh, and the purity of the magnesium oxide powder is more than 90%.

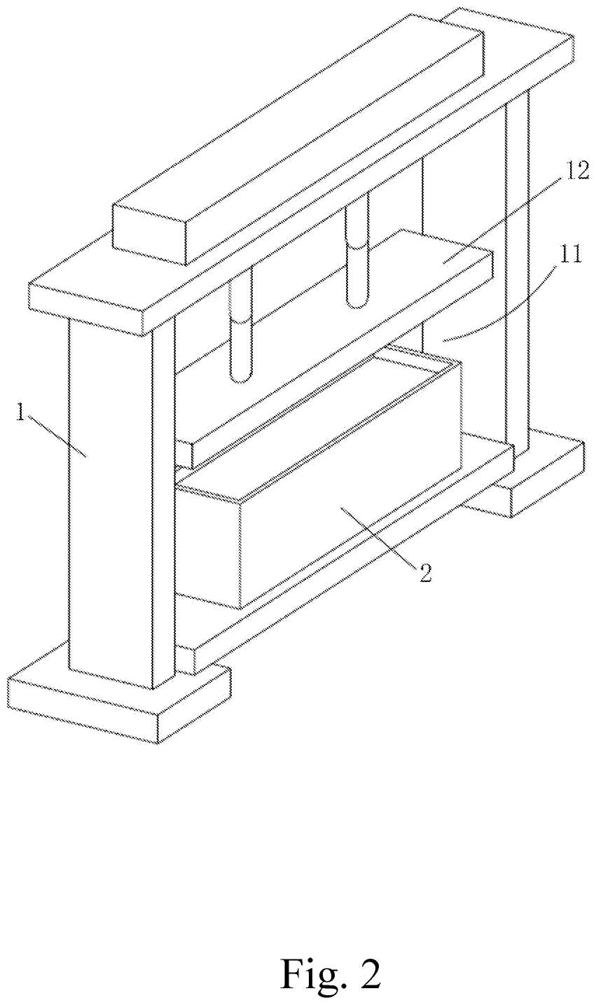

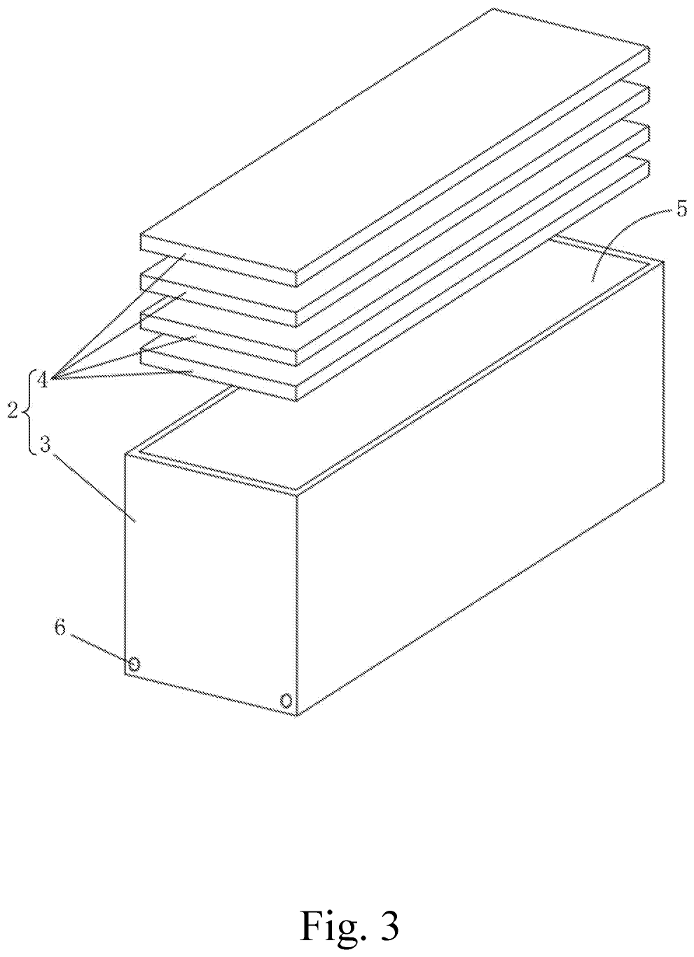

As shown in FIG. 2 and FIG. 3,

the embodiment of the invention further provides a cold-pressing processing system for plant fiber boards, comprising:

a mixing and stirring machine, mainly used for mixing and fully and uniformly stirring plant fiber and a cold-pressing adhesive therein;

a cold-pressing device, mainly used for paving the uniformly mixed plant fiber and cold-pressing adhesive in a cold-pressing die set of the cold-pressing device for cold-pressing and curing to prepare a plant fiber block; wherein the cold-pressing device comprises a cold-pressing machine 1 and the cold-pressing die set 2 arranged on a cold-pressing station 11 of the cold-pressing machine 1, the cold-pressing die set 2 consists of a detachable concave frame-shaped cold-pressing die 3 and more than one pressing block 4, and the shape and size of the pressing blocks 4 are matched with an inner die cavity 5 of the cold-pressing die 3; specifically, the length, width and height of the inner die cavity 5 of the cold-pressing die 3 can be 250 cm, 127 cm and 170 cm respectively, and the length, width and height of the pressing blocks 4 are 249.6 cm, 126.6 cm and 20 cm respectively; in use, the pressing blocks 4 are stacked in the inner die cavity 5 on the mixture 7 of the plant fiber powder and the adhesive in the inner die cavity 5;

a cutting device which could be a horizontal band saw and is used for cutting the plant fiber block into a plurality of plant fiber board blanks with a required thickness; an edge cutting machine, used for final trimming and edging finishing of the plant fiber board blanks;

and a sanding machine, used for sanding the surface and edge of the plant fiber board blanks.

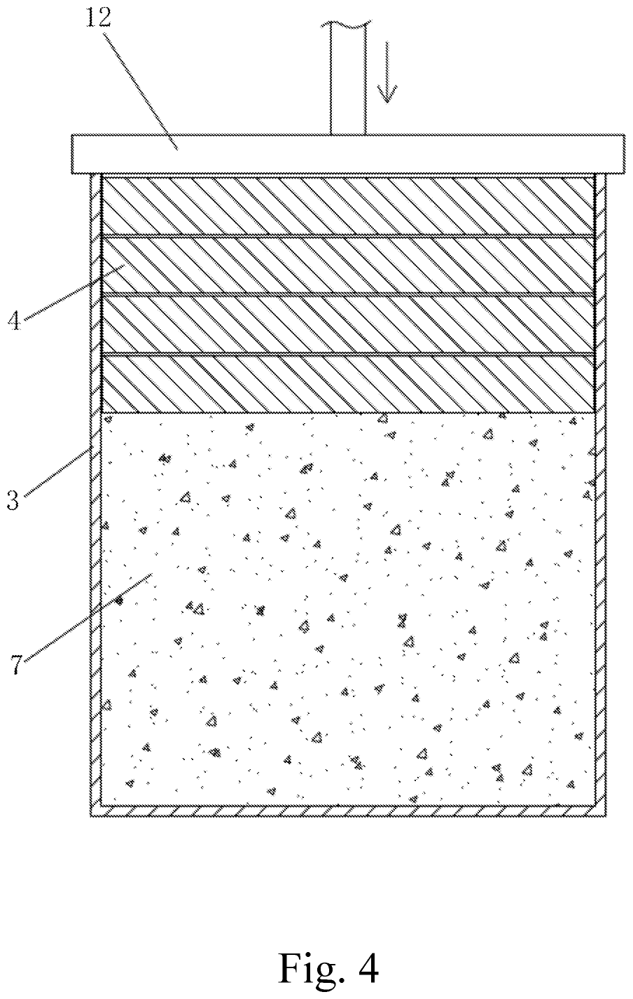

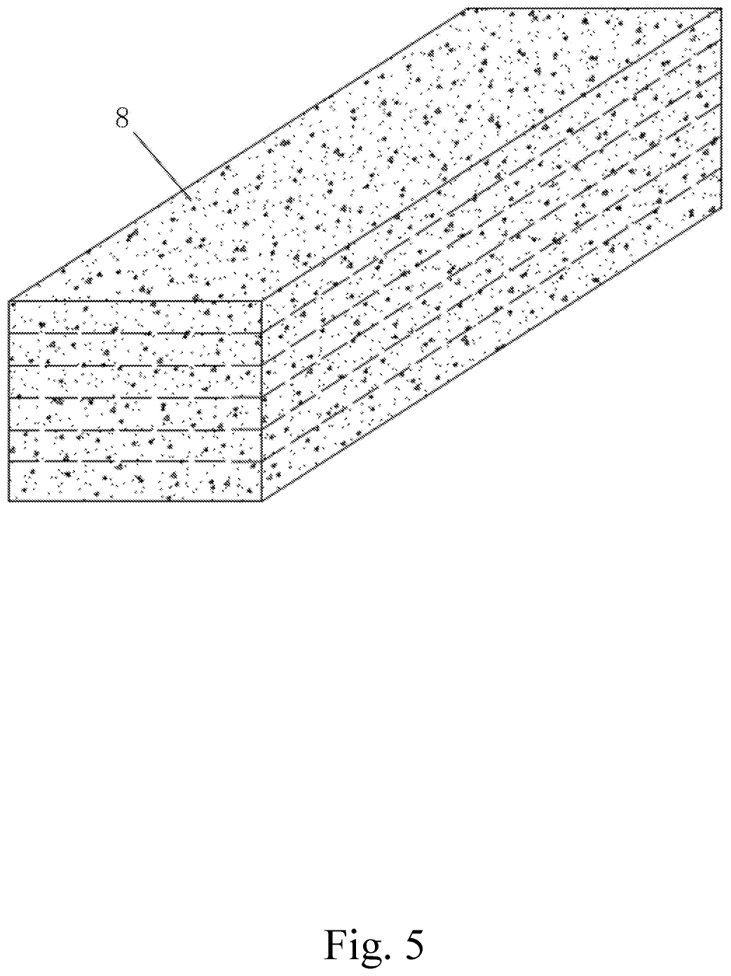

When the cold-pressing processing system is used for processing plant fiber boards, firstly the plant fiber and the adhesive are put in the mixing and stirring machine based on the above ratio to be mixed and fully and uniformly stirred; then the uniformly mixed plant fiber powder and adhesive are injected into the inner die cavity 5 of the cold-pressing die 3, and the pressing blocks 4 are stacked in the inner die cavity 5 on the mixture 7 of the plant fiber powder and the adhesive in the inner die cavity 5 (as shown in FIG. 4); then the cold-pressing machine 1 is started to press, at this time, a lower press plate 12 of the cold-pressing machine 1 presses the pressing blocks 4 downwards (the pressure is 16 kg/cm2 or more), and after a period of time, the cold-pressing die 3 is opened (released) to produce the molded plant fiber block 8 (as shown in FIG. 5) with a height of about 100 cm; next, the cutting device is adopted for cutting the plant fiber block into the plurality of plant fiber board blanks with a required thickness; and finally the edge cutting machine and the sanding machine are adopted for edge cutting treatment and sanding treatment in sequence to obtain the plant fiber boards.

In this way, by means of the cold-pressing processing method and system for plant fiber boards, plant fiber boards can be prepared through cold-pressing, hot-pressing is not needed, investment in mechanical equipment and energy consumption can be greatly reduced, production cost is reduced, market competitiveness is remarkably improved, and no formaldehyde or other harmful substances are released so environment-friendliness is realized; furthermore, the structure is simple, implementation is easy, and the cost is low. The cold-pressing processing method and system for plant fiber boards are particularly suitable for small enterprises and conducive to promotion and popularization.

Besides, the lower end of the side surface of the cold-pressing die 3 is provided with residual adhesive discharge holes 6, and the residual adhesive discharge holes 6 are connected with the inner die cavity 5, wherein the residual adhesive discharge holes 6 may be provided at the corners of the lower ends of the side surfaces of the front and rear ends (of course, they may also be provided at one or all of the side surfaces and may also be at any position of the lower ends of the side surfaces). In this way, excess adhesive can be discharged during the cold-pressing process to further improve and ensure the quality of products.

According to the cold-pressing processing method for plant fiber boards, after edge cutting and before sanding treatment, the plant fiber board blanks subjected to edge cutting need to be cured to reduce the moisture content, i.e. the plant fiber board blanks subjected to edge cutting are put into drying equipment for stoving treatment or air-seasoning treatment to reduce the moisture content. Accordingly, the cold-pressing processing system for plant fiber boards further comprises drying equipment. In this way, the prepared plant fiber boards have more stable performance and better quality.

Furthermore, the invention also provides a cold-pressing adhesive for plant fiber boards, the cold-pressing adhesive is prepared by mixing equal amounts of magnesium sulfate aqueous solution and magnesium oxide powder, and fully and uniformly stirring the mixture, the magnesium sulfate aqueous solution is prepared by fully and uniformly mixing 45-46% by weight of magnesium sulfate, 45-46% by weight of water, and 8-10% by weight of waterproof agent, and the ratio of magnesium sulfate to water is 1:1. During preparation, firstly, magnesium sulfate is weighed and dissolved in the same amount of water (i.e., magnesium sulfate:water=1:1) and fully stirred, then 8-10% by weight of waterproof agent is added into the magnesium sulfate aqueous solution and fully and uniformly stirred to improve the strength and water resistance of a glued product, so the magnesium sulfate aqueous solution is obtained; and then magnesium oxide powder (purity above 90%) equal to the magnesium sulfate aqueous solution is weighed and added into the magnesium sulfate aqueous solution, and fully and uniformly stirred to prepare a special adhesive for cold-pressing processing of plant fiber boards, the adhesive is a formaldehyde-free inorganic liquid adhesive and can also be used for cold-pressing processing of wood-based panels such as plywood and particleboards, that is, wood veneers (medium plate or front plate) are evenly coated with the adhesive and are combined into “multi-layer board blanks”, and a steel plate, aluminum plate or rigid PVC plastic plate with a thickness of 2-6 mm is placed between different groups of “multi-layer board blanks” to form a “board stack”, and the “board stack” is sent into the cold-pressing machine to be pressurized and cured.

The foregoing is a preferred embodiment of the present invention, and it should be noted that for those of ordinary skills in the art, several modifications and retouching can be made without departing from the principles of the present invention, and these modifications and retouching are also regarded as the scope of protection of the present invention.

1. A cold-pressing adhesive for plant fiber boards, the adhesive being prepared by mixing equal amounts of magnesium sulfate aqueous solution and magnesium oxide powder, and fully and uniformly stirring the mixture, wherein the magnesium sulfate aqueous solution is prepared by fully and uniformly mixing 45-46% by weight of magnesium sulfate, 45-46% by weight of water, and 8-10% by weight of waterproof agent, and the ratio of magnesium sulfate to water is 1:1.

2. The cold-pressing processing method for plant fiber boards according to claim 1, wherein the mixing ratio of the plant fiber to the adhesive is 1:1.5 during sizing and mixing, and the adhesive is prepared by mixing equal amounts of magnesium sulfate aqueous solution and magnesium oxide powder and fully and uniformly stirring the mixture.

3. The cold-pressing processing method for plant fiber boards according to claim 2, wherein the plant fiber is powder or fiber of more than 200 mesh, and the purity of the magnesium oxide powder is more than 90%.

4. The cold-pressing processing method for plant fiber boards according to claim 1, wherein the step that “the uniformly mixed plant fiber and adhesive are paved in a cold-pressing die set of a cold-pressing device for cold-pressing and curing to prepare a plant fiber block” specifically comprises the steps of injecting the uniformly mixed plant fiber and adhesive into an inner die cavity of a cold-pressing die firstly, then stacking pressing blocks in the inner die cavity on the mixture of the plant fiber powder and the adhesive in the inner die cavity, starting a cold-pressing machine to press for a period of time and then opening the cold-pressing die to obtain the molded plant fiber block.

5. The cold-pressing processing method for plant fiber boards according to claim 1, wherein after cutting out the plant fiber board blanks and before edge cutting, the plant fiber board blanks need to be cured to reduce the moisture content, i.e. the plant fiber board blanks are put into drying equipment for stoving treatment or air-seasoning treatment to reduce the moisture content.

6. A cold-pressing processing system for plant fiber boards, comprising:
a mixing and stirring machine, used for mixing and fully and uniformly stirring plant fiber and a cold-pressing adhesive therein;
a cold-pressing device, used for paving the uniformly mixed plant fiber and cold-pressing adhesive in a cold-pressing die set of the cold-pressing device for cold-pressing and curing to prepare a plant fiber block; wherein the cold-pressing device comprises a cold-pressing machine and the cold-pressing die set arranged on a cold-pressing station of the cold-pressing machine, the cold-pressing die set consists of a detachable concave frame-shaped cold-pressing die and more than one pressing block, and the shape and size of the pressing blocks are matched with an inner die cavity of the cold-pressing die; in use, the pressing blocks are stacked in the inner die cavity on the mixture of the plant fiber powder and the adhesive in the inner die cavity;
a cutting device, used for cutting the plant fiber block into a plurality of plant fiber board blanks with a required thickness;
an edge cutting machine, used for final trimming and edging finishing of the plant fiber board blanks;
and a sanding machine, used for sanding the surface and edge of the plant fiber board blanks.

7. The cold-pressing processing system for plant fiber boards according to claim 6, wherein the lower end of the side surface of the cold-pressing die is provided with residual adhesive discharge holes, and the residual adhesive discharge holes are connected with the inner die cavity.

8. The cold-pressing processing system for plant fiber boards according to claim 6, further comprising drying equipment, used for stoving treatment or air-seasoning treatment of the plant fiber board blanks therein to reduce the moisture content.

9. A cold-pressing processing system for plant fiber boards, comprising the following production steps of:
sizing and mixing, wherein plant fiber and an adhesive are mixed and fully and uniformly stirred;
paving and cold-pressing, wherein the uniformly mixed plant fiber and adhesive are paved in a cold-pressing die set of a cold-pressing device for cold-pressing and curing to prepare a plant fiber block;
cutting, wherein the plant fiber block is cut into a plurality of plant fiber board blanks with a required thickness;
edge cutting, wherein the plant fiber board blanks are subjected to final trimming and edging finishing;
and sanding treatment, wherein the surface and edge of the plant fiber board blanks are sanded to obtain the plant fiber boards.
